(19) United States
(12) Patent Application Publication
(10) Pub. No.: US 2006/0053479 A1
(43) Pub. Date: Mar. 9, 2006

(54) Accessing a data item in a memory of a computer system

(76) Inventors: Gordon Douglas Hutchison, Eastleigh (GB); David Geoffrey Screen, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/220,962

(22) Filed: Sep. 7, 2005

(30) Foreign Application Priority Data
Sep. 8, 2004 (GB) 0419889.1

(51) Int. Cl. H04L 9/00

(52) U.S. Cl. 726/1

(57) ABSTRACT

A method for protecting sensitive data items which must be accessed data item in a memory of a computer system. A data hiding policy is defined. The policy includes one or more policy entries, each policy entry corresponding to an attribute of a data item and each policy entry indicating whether a data item having said attribute is to be hidden. When each data item is retrieved from the memory of the computer system, a determination is made whether a policy entry includes an indication that the retrieved data item is to be protected from exposure. If the data item is to be protected, an obscured representation of the data item is generated for external presentation. Obscuration may be accomplished by obfuscation, encryption, or encryption.

### FIELD OF THE INVENTION

This invention relates to accessing a memory of a production computer system. In particular it relates to hiding sensitive information in a memory of a production computer system.

### BACKGROUND OF THE INVENTION

Identification and correction of errors in software is an important part of the software development process. An error can manifest in many ways including an incorrect data value, an incorrect flow of application logic or a failure of all or part of a software application. More subtly, errors can result in synchronization and timing problems in the execution of an application which may be difficult or impossible to reproduce. Where an error is identified at application development time, techniques can be employed to diagnose and resolve errors. However, runtime errors in a production system typically require diagnosis in-place within the production environment. This can entail the use of memory scanning tools to access data structures in a memory of a production computer system in order to diagnose and resolve the runtime errors.

Effective methods exist to access and work with the contents of a memory at runtime. For example, memory scanning tools can scan through a log of an application memory area in order to identify data items of a particular data type, or to extract individual data fields. However, accessing the memory of a production computer system can present security issues, especially if sensitive data is stored in the memory. For example, a financial institution stores confidential personal and financial information for customers and this information may be present in the memory of a production computer system at the time of a problem. Service engineers from a vendor company who access the memory of the production system may then have access to the confidential information.

One solution to this problem is to provide diagnosis tools and associated instructions to staff who are authorised to access the confidential information. However the skills required to diagnose and fix runtime errors are specialized and this indirect approach to problem diagnosis can be burdensome, inefficient and often ineffective.

It would therefore be desirable to provide a way for service engineers to diagnose and debug errors in a memory of a production computer system without exposing sensitive or confidential information which may be stored in the memory.

### SUMMARY OF THE INVENTION

The present invention accordingly provides, in a first aspect, a method for accessing a data item in a memory of a computer system, the method comprising the steps of: defining a data hiding policy including one or more policy entries, each policy entry corresponding to an attribute of a data item and each policy entry indicating whether a data item having said attribute is to be hidden; retrieving the data item from the memory of the computer system; responsive to a determination that a policy entry includes an indication that the accessed data item is to be hidden, generating an obscured data item from the accessed data item. The data hiding policy defines data items in the memory of the computer system which are to be hidden so preventing unauthorised readers of the memory from accessing sensitive information which may be stored in the data items.

The present invention accordingly provides, in a second aspect, a memory access proxy for accessing a data item in a memory of a computer system. The proxy includes means for defining a data hiding policy including one or more policy entries, each policy entry corresponding to an attribute of a data item and each policy entry indicating whether a data item having said attribute is to be hidden; means for retrieving the data item from the memory of the computer system; means responsive to a determination that a policy entry includes an indication that the accessed data item is to be hidden for generating an obscured data item from the accessed data item.

The present invention accordingly provides, in a third aspect, a computer program product comprising computer program code stored on a computer readable storage medium which, when executed on a data processing system, instructs the data processing system to carry out the method as described above.

### BRIEF DESCRIPTION OF THE DRAWINGS

A preferred embodiment of the present invention will now be described, by way of example only, with reference to the accompanying drawings, in which:

FIG. 1a is a block diagram of a computer system in which the present invention can be implemented;

FIG. 1b is a schematic diagram illustrating an arrangement of a memory access proxy 100 in a computer system;

FIG. 2a is a schematic diagram of a memory structure for use in a memory access proxy including exemplary data items;

FIG. 2b illustrates a method for providing a data item to a data item requestor;

FIG. 3 illustrates a method executed by a data hider in a memory access proxy;

FIG. 4 illustrates a method executed by a data hider for nested policy entries in a data hiding policy;

FIG. 5 illustrates a method executed by a data hider for recursively hiding nested objects;

FIG. 6 is a memory structure including exemplary data items;

FIG. 7 illustrates a method executed by a data hider; and

FIG. 8 illustrates a method for generating a list of all references to a requested field starting from root objects.

### DETAILED DESCRIPTION OF THE PREFERRED EMBODIMENT

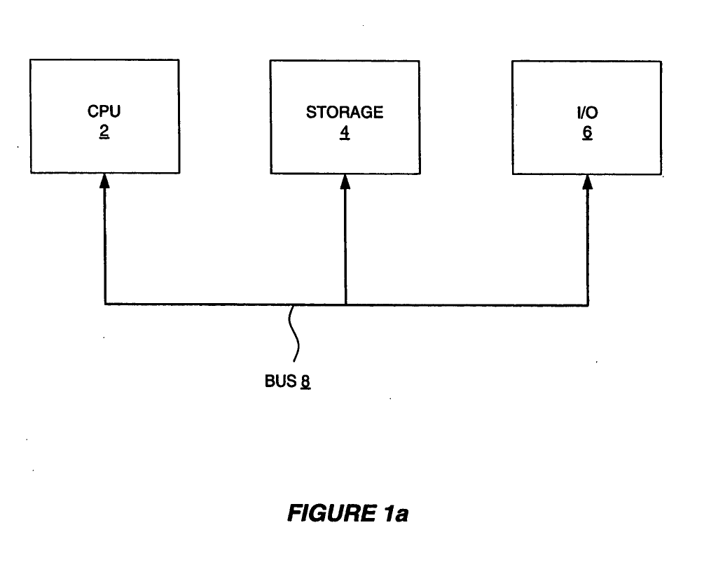

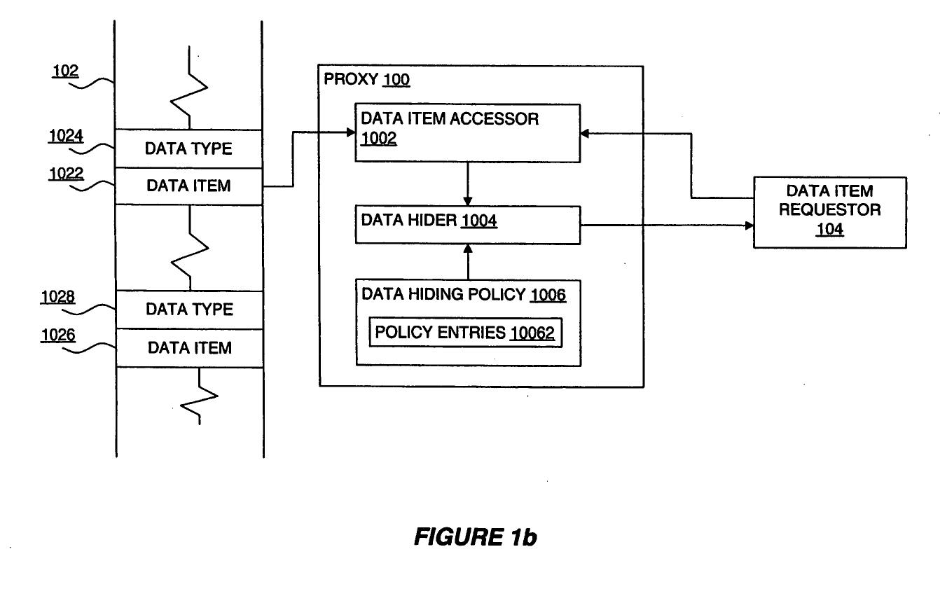

FIG. 1a is a block diagram of a computer system in which the present invention can be implemented. A central processor unit (CPU) 2 is communicatively connected to a storage 4 and an input/output (I/O) interface 6 via a data bus 8. The storage 4 can be any read/write storage device such as a random access memory (RAM) or a non-volatile storage device. An example of a non-volatile storage device includes a disk or tape storage device. The I/O interface 6 is an interface to devices for the input or output of data, or for both input and output of data. Examples of I/O devices connectable to I/O interface 6 include a keyboard, a mouse, a display (such as a monitor) and a network connection.

FIG. 1b is a schematic diagram illustrating an arrangement of a memory access proxy 100 in a computer system in accordance with a preferred embodiment of the present invention. The memory access proxy 100 is a software component which accesses a memory 102 of a production computer system at runtime. The memory access proxy 100 may reside as a software process on the production computer system. Alternatively, the memory access proxy 100 may reside on a separate computer system which is communicatively connected to the production computer system. Data items 1022 and 1026 are data structures stored in the memory 102. Each of the data items 1022 and 1026 has a corresponding data type 1024 and 1028 respectively. The data items 1022 and 1026 can be data structures or software objects. The data types 1024 and 1028 can be data structure types or classes. Particular examples of data items and data types are considered below. While two data items are illustrated in the memory 102 of FIG. 1b it will be appreciated by those skilled in the art that any number of data items could be stored in the memory 102.

The memory access proxy 100 includes a data item accessor 1002, a data hider 1004 and a data provider 1006. The data item accessor 1002 is a memory access software function which is able to retrieve one or more data items 1022 and 1026 from the memory 102. The data hider 1004 is a software function which obscures a data item. For example, data hider 1004 can be an encrypter which encrypts a data item. Alternatively, data hider 1004 can be an obfuscation routine which obfuscates the value of a data item such that when a data item is obfuscated it does not resemble its original. Alternatively, data hider 1004 can be a substitutor or a mapper which, when presented with a data item, outputs a substitute data item based on a table of substitutions. Preferably, the data hider 1004 reversibly obscures a data item so that it can be subsequently un-obscured. For example, an ecrypted data item can be subsquently decrypted, and a substituted data item can be subsequently re-substituted by its original. Techniques such as encryption, obfuscation and substitution are well known in the art and will not be discussed further here.

The memory access proxy 100 further includes a data hiding policy 1006. The data hiding policy is a security policy defining which of the data items in the memory 102 should be hidden by the data hider 1004. The memory access proxy 100 includes policy entries 10062 corresponding to individual data types 1024 or 1028. Additionally, the policy entries 10062 can correspond to individual fields in a data item, as will be considered below.

FIG. 1b further illustrates a data item requestor 104 which is a memory scanning tool employed by service engineers to diagnose and correct errors in a production computer system. The data item requestor 104 is configured to access the memory 102 of the production computer system. However, the data item requestor 104 is isolated from the memory 102 via the memory access proxy 100. In fact, the data item requestor 104 is preferably restricted to accessing the memory 102 only through the memory access proxy 100. For example, the data item requestor 104 executes on a computer system which is separated from the production computer system including the memory 102. The data item requester 104 sends requests to the memory access proxy 100 to access the memory 102. Such requests can include requests for data items of a particular data type, or requests for particular data fields from the memory 102. For example, a pseudo-code request from the data item requestor 104 may take the form “send all data items of type String”. Alternatively, a request may take the form “send the age field of the person object with the name ‘Polly’”.

In use, the data item requestor 104 sends a request for one or more data items to the memory access proxy 100. The data item accessor 1002 locates and retrieves the requested data items from the memory 102. Subsequently, the data hider 1004 interrogates the data hiding policy 1006 to determine if any of the retrieved data items should be hidden (e.g. through encryption, obfuscation or substitution). The data hider 1004 obscures data items in accordance with the data hiding policy and provides the obscured data items to the data item requestor 104.

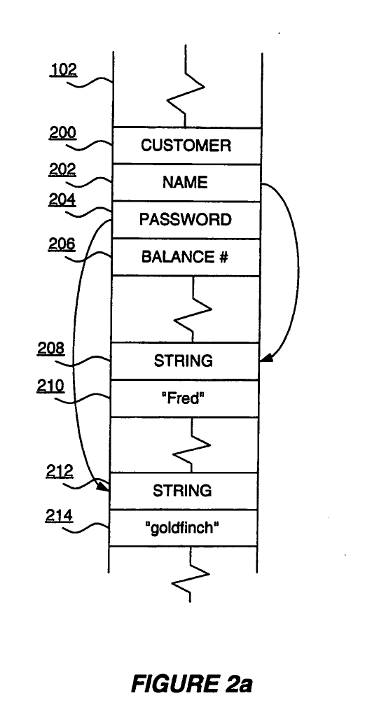

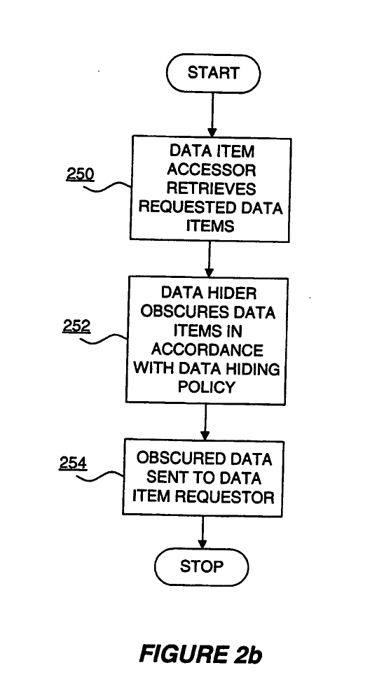

FIG. 2a is a schematic diagram of an arrangement of the memory 102 of FIG. 1b including exemplary data items stored therein in accordance with a preferred embodiment of the present invention. The memory 102 of FIG. 2a includes a Customer object 200 which is an instance of a class of type “Customer”. The Customer object 200 includes three fields: a Name field 202; a Password field 204; and a Balance field 206. The Name field 202 and Password field 204 are references to String object 208 and String object 212 respectively. String objects 208 and 212 are instances of a class of type “String”. String object 208 includes a character string with the value “Fred”. String object 214 includes a character string with the value “goldfinch”. The Balance field 206 of the Customer object 200 is a primitive numeric field, such as an integer or real number, and is accordingly stored in-line as part of the Customer object 200.

Methods of the arrangement of FIG. 1b will now be considered in use by way of example for the arrangement of memory 102 of FIG. 2a. Example 1 below illustrates an exemplary data hiding policy 1006 including a single policy entry 10062 for the Customer data type. The operation of the memory access proxy 100 is such that data items retrieved by the data item accessor 1002 which have one of the data types in the data hiding policy 1006 must be hidden by the data hider 1004 before they are supplied to the data item requestor 104. Thus, data items with the data type Customer will be hidden by the data hider 1004.

Example 1

Data Hiding Policy 1006
   Policy Entries 10062
      Customer

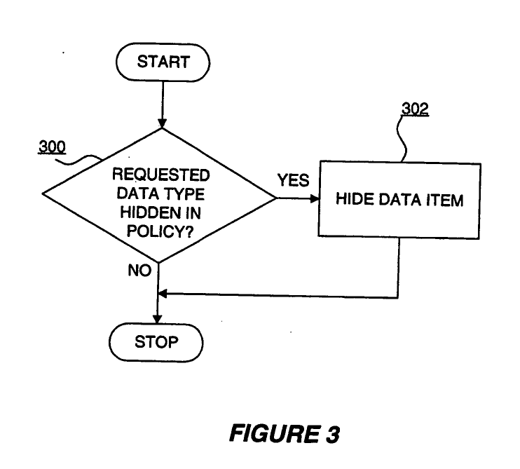

FIG. 2b illustrates a method for providing a data item to the data item requester 104 in accordance with a preferred embodiment of the present invention. FIG. 2b will now be described in relation to the data hiding policy 1006 of Example 1 and the arrangement of memory 102 of FIG. 2a where the data item requestor 104 requests all objects of data type Customer. At step 250 the data item accessor 1002 retrieves the requested data items from the memory 102. The Customer object 200 is therefore retrieved by the data item accessor 1002 at step 250. At step 252 the data hider 1004 refers to the data hiding policy 1006 to determine if the Customer object 200 is to be obscured. A more detailed method corresponding to step 252 is illustrated in FIG. 3. At step 300 of FIG. 3, the method checks to see if an entry exists for the Customer data type in the data hiding policy 1006. The data hiding policy 1006 of Example 1 includes a policy entry 10062 for the Customer data type, and consequently the method proceeds to step 302 where the Customer object 200 is hidden by the data hider 1004. Returning now to FIG. 2b, at step 254 the obscured data is sent to the data item requestor 104. Thus, the Customer object 200 is obscured before being sent to the data item requestor 104.

While the example above demonstrates how a Customer object 200 is obscured where a policy entry 10062 exists for the Customer data type, it is noted that the particular implementation of the data hider 1004 illustrated in FIG. 3 does not hide objects referenced by a Customer object. For example, the String object 208 (corresponding to the Name field 202 of the Customer object 200) is not hidden by the method of FIG. 3 because the Name data type is not included in the data hiding policy 1006 of Example 1. Thus, for the Customer object 200 to be completely obscured by the memory access proxy 100 it is necessary to include the String data type in the data hiding policy 1006 of Example 1.

An alternative to the necessary inclusion of additional data types in the data hiding policy 1006 is to employ a nested enforcement of the data hiding policy 1006. Example 2 below illustrates the data hiding policy of Example 1 with the addition of a “nested” attribute to indicate to the data hider 1004 that the policy should apply to data items of the type specified in the policy entries 10062 and any objects referenced by the data items.

Example 2

Data Hiding Policy 1006
   Policy Entries 10062
      Customer NESTED

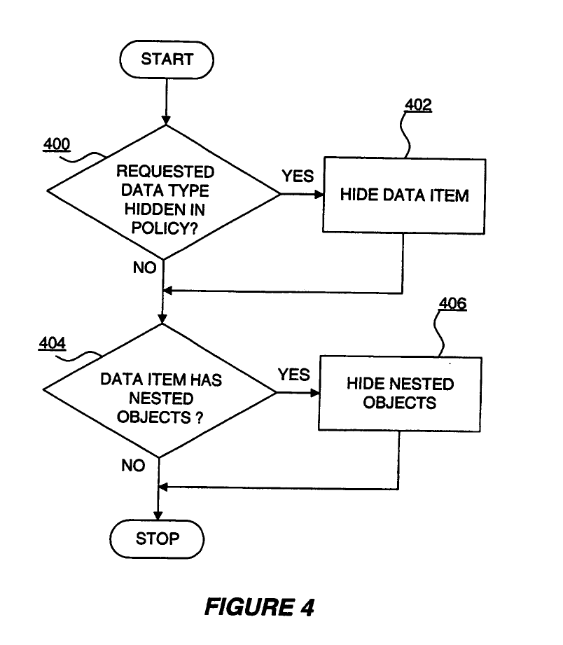

The method described in FIG. 2b uses the data hiding policy 1006 of Example 2 and the arrangement of memory 102 of FIG. 2a where the data item requestor 104 requests all objects of data type Customer. At step 250 the data item accessor 1002 retrieves the requested data items from the memory 102. The Customer object 200 is therefore retrieved by the data item accessor 1002 at step 250. At step 252 the data hider 1004 refers to the data hiding policy 1006 to determine if the Customer object 200 is to be obscured. A more detailed method corresponding to step 252 for nested policy entries 10062 is illustrated in FIG. 4. At step 400 of FIG. 4 the method checks to see if an entry exists for the Customer data type in the data hiding policy 1006. The data hiding policy 1006 of Example 2 includes a policy entry 10062 for the Customer data type, and consequently the method proceeds to step 402 where the Customer object 200 is hidden by the data hider 1004. Subsequently at step 404 the method determines if the Customer object 200 has any nested objects. The Name field 202 and the Password field 204 are both nested object references from the Customer object 200, and so the method proceeds to step 406. At step 406 the String object 208 referenced by the name field 202 and the String object 212 referenced by the password field 204 are obscured. Returning now to FIG. 2b, at step 254 the obscured data is sent to the data item requestor 104. Thus Customer object 200, String object 208 and String object 212 are obscured before being sent to the data item requestor 104.

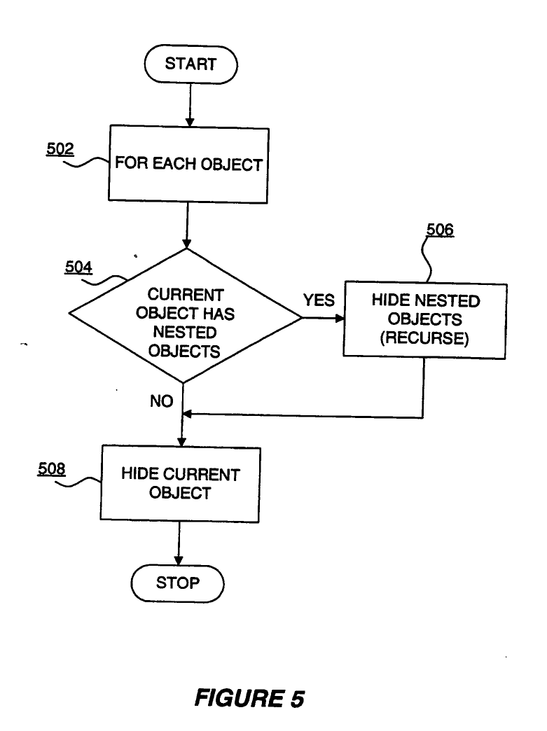

In situations where there are multiple levels of nesting of objects step 406 of FIG. 4 can be elaborated to the recursive method of FIG. 5. Considering the method of FIG. 5, at step 502 a loop is initiated through each object nested in a parent object. At step 504, for a current object, if the current object has nested objects the method recurses at step 506. At step 508 the current object is hidden before the method returns.

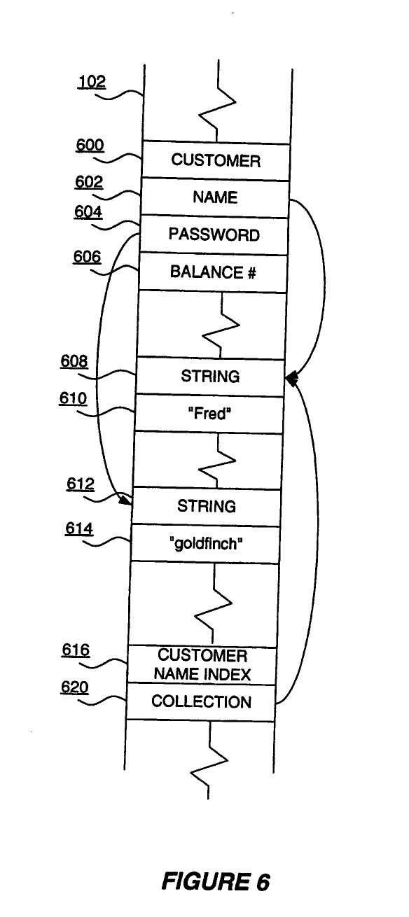

FIG. 6 is a schematic diagram of a further arrangement of the memory 102 of FIG. 1b including exemplary data items stored therein in accordance with a preferred embodiment of the present invention. Many of the elements of FIG. 6 are identical to those described with respect to FIG. 2a and these will not be repeated here. FIG. 6 further includes a Customer Name Index object 616 of type “Index”. The customer Name Index object 616 includes a Collection field 620 which is a reference to zero or more String objects. In the particular arrangement of FIG. 6 the Collection field 620 includes a reference to String object 608. It is to be noted that the String object 608 is additionally referenced by the Name field 602 of the Customer object 600. Thus the String object 608 is referenced by two objects in the memory 102.

Referring to the memory structure shown in FIG. 6, Example 3 below illustrates an exemplary data hiding policy 1006 including a single policy entry 10062 for the Customer.Name field. The Customer.Name field corresponds to the object referenced by the Name field 602 of the Customer object 600. The operation of the memory access proxy 100 is such that data items retrieved by the data item accessor 1002 which are accessible by a Customer.Name reference must be hidden by the data hider 1004 before they are supplied to the data item requester 104.

Example 3

Data Hiding Policy 1006
   Policy Entries 10062
      Customer.Name

The method shown in FIG. 2b will now be applied for the data hiding policy 1006 of Example 3 and the arrangement of memory 102 of FIG. 6 where the data item requester 104 requests the Name field 602 of the Customer Object 600. At step 250 the data item accessor 1002 retrieves the requested data item from the memory 102. The Customer object 600 is therefore retrieved by the data item accessor 1002 at step 250, and subsequently the Name field 602 is accessed to obtain a reference to the String object 608. At step 252 the data hider 1004 refers to the data hiding policy 1006 to determine if the String object 608 is to be obscured. The String object 608 was referenced via the Customer object 600 and so the String object 608 is a Customer.Name field. Accordingly the data hider 1004 obscures the String object 608. At step 254 the obscured data is sent to the data item requestor 104. Thus, the String object 608 is obscured before being sent to the data item requester 104.

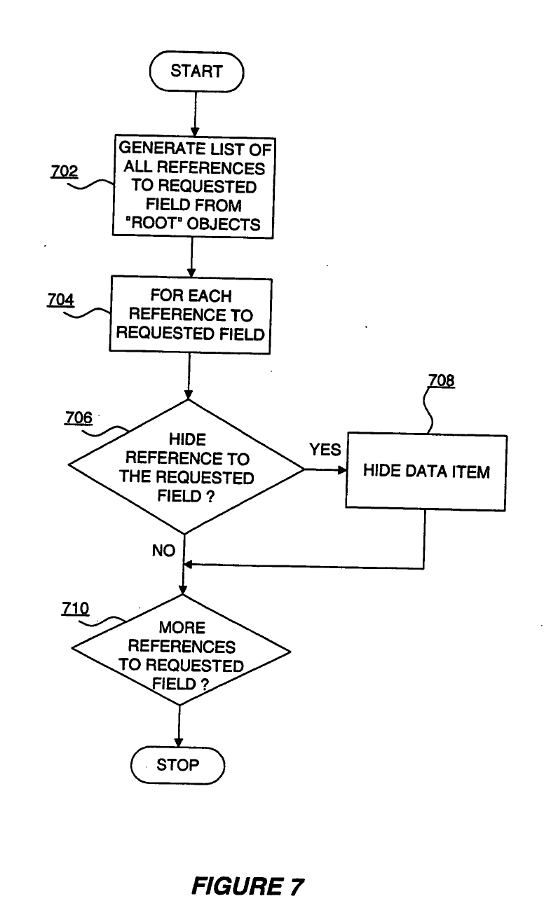

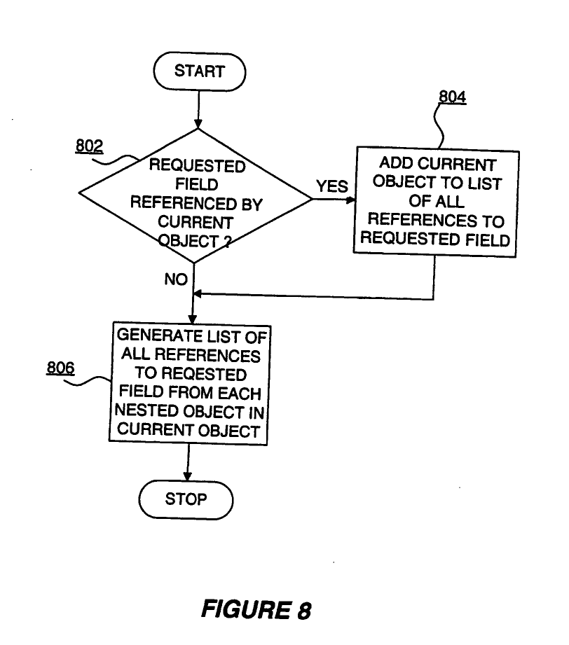

It is noted that the String object 608 is also accessible via the Collection field 620 of the Customer Name Index object 616. However, this route to the String object 608 does not involve a Customer.Name field because the Customer object 200 is not involved. Consequently, the method of FIG. 2b described above would not obscure the String object 608 when accessed via the Collection field 620 of the Customer Name Index object 616. This may present a security exposure where the intention is to prevent access to the String object 608. FIGS. 7 and 8 illustrate methods for identifying all routes of access to an object when interpreting the data hiding policy 1006 in order to overcome this problem.

The system shown in FIG. 2B can be used to implement the methods shown in FIGS. 7 and 8, for the data hiding policy 1006 of Example 3 and the arrangement of memory 102 of FIG. 6 where the data item requester 104 requests the Collection field 620 of the Customer Name Index object 616. At step 250 the data item accessor 1002 retrieves the requested data item from the memory 102. The Customer Name Index object 616 is therefore retrieved by the data item accessor 1002 at step 250, and subsequently the Collection field 620 is accessed to obtain a reference to the String object 608. At step 252 the data hider 1004 refers to the data hiding policy 1006 to determine if the String object 608 is to be obscured.

Considering step 252 in detail with reference to FIG. 7, at step 702 a list of all references to String object 608 is generated starting from a set of “root” objects. A root object is an object for which no different object holds a reference. A memory scanner is able to identify the root objects in a memory log. In the arrangement of memory 102 of FIG. 6 there are two root objects: the Customer object 600; and the Customer Name Index object 616.

FIG. 8 illustrates in detail a method corresponding to step 702 to generate a list of all references to String object 608 starting from root objects. Considering the method of FIG. 8 for the root object Customer 600, at step 802 the method determines that the String object 608 is referenced by the Customer object 600 (via Name field 602) and at step 804 the Customer object 600 is added to a list of all references to the requested field object. At step 806 the method recurses the method of FIG. 8 for all nested object of Customer object 600, of which none refer to String object 608. Considering also the method of FIG. 8 for the root object Customer Name Index 616, at step 802 the method determines that the String object 608 is referenced by the Customer Name Index object 616 (via Collection field 620) and at step 804 the Customer Name Index object 616 is added to a list of all references to the requested field object. At step 806 the method recurses the method of FIG. 8 for all nested object of Customer Name Index object 616, of which there are none. Consequently, following the method of FIG. 8 for the root objects Customer 600 and Customer Name Index 616 the list of all references to String object 608 includes: Customer object 600; and Customer Name Index 616.

Returning now to step 704 of FIG. 7, a loop is initiated through the objects in the list of references to String object 608. Starting with the reference to String Object 608 via the Name field 602 of the Customer object 600, at step 706 the data hider 1004 refers to the data hiding policy 1006 to determine if the String object 608 is to be obscured. The data hiding policy 1006 includes an policy entry 10062 for the Customer.Name field. The String object 608 is thus referenced via the Customer object 600 and so the String object 608 is a Customer.Name field. Accordingly the data hider 1004 obscures the String object 608 at step 708. Subsequently at step 710 the loop returns to step 706 for the reference to String Object 608 via the Collection field 620 of the Customer Name Index object 616. The String object 608 is not referenced via a Customer.Name field via the Customer Name Index object 616 and so the method proceeds to step 710 and ends.

Returning finally to step 254 of FIG. 2b, the obscured data is sent to the data item requestor 104. Thus, the String object 608 is obscured before being sent to the data item requestor 104 because it is accessible via the Customer.Name field which is included in the data hiding policy 1006. This is despite the reference to the String object 608 being made via the Customer Name Index object 616.

What is claimed is:

1. A computer-implemented method for accessing a data item in a memory of a computer system, the method comprising the steps of:
defining a data hiding policy including one or more policy entries, each policy entry corresponding to an attribute of a data item and each policy entry indicating whether a data item having said attribute is to be hidden;
retrieving the data item from the memory of the computer system;
responsive to a determination that a policy entry includes an indication that the accessed data item is to be hidden, generating an obscured data item representing the accessed data item.

2. The computer-implemented method of claim 1 wherein the attribute of a data item is a data type.

3. The computer-implemented method of claim 1 wherein the attribute of a data item is a data field.

4. The computer-implemented method of claim 1 wherein the obscured data item is an encrypted data item.

5. The computer-implemented method of claim 1 wherein the obscured data item is an obfuscated data item.

6. The computer-implemented method of claim 1 wherein the obscured data item is a substituted data item.

7. A memory access proxy for accessing a data item in a memory of a computer system, the proxy comprising:
means for defining a data hiding policy including one or more policy entries, each policy entry corresponding to an attribute of a data item and each policy entry indicating whether a data item having said attribute is to be hidden;
means for retrieving the data item from the memory of the computer system; and
means responsive to a determination that a policy entry includes an indication that the accessed data item is to be hidden for generating an obscured data item representing the accessed data item.

8. The memory access proxy of claim 7 wherein the attribute of a data item is a data type.

9. The memory access proxy of claim 7 wherein the attribute of a data item is a data field.

10. The memory access proxy of claim 7 wherein the obscured data item is an encrypted data item.

11. The memory access proxy of claim 7 wherein the obscured data item is an obfuscated data item.

12. The memory access proxy of claim 7 wherein the obscured data item is a substituted data item.

13. A computer program product comprising computer program code stored on a computer readable storage medium which, when executed on a data processing system, causes the system to:
define a data hiding policy including one or more policy entries, each policy entry corresponding to an attribute of a data item and each policy entry indicating whether a data item having said attribute is to be hidden;
retrieve the data item from the memory of the computer system;
responsive to a determination that a policy entry includes an indication that the accessed data item is to be hidden, generate an obscured data item representing the accessed data item.
